(19) United States
(12) Patent Application Publication
(10) Pub. No.: US 2012/0141647 A1
(43) Pub. Date: Jun. 7, 2012

(54) BATTER MIX COMPOSITION WITH REDUCED OIL ABSORPTION

(75) Inventors: Young Jae Kim, Seoul (KR); Sun Seob Song, Siheung-si (KR); Chun Son Lim, Seoul (KR); Hyeon Gyu Lee, Seoul (KR); Su Yong Lee, Seoul (KR); In Young Bae, Seoul (KR); Deok Nyun Kim, Guri-si (KR); Yoo Jin Lee, Seoul (KR)

(73) Assignee: CJ CHEILJEDANG CORP., Seoul (KR)

(21) Appl. No.: 13/389,073

(22) PCT Filed: Aug. 4, 2010
(86) PCT No.: PCT/KR2010/005109

§ 371 Date: Feb. 6, 2012

(30) Foreign Application Priority Data
Aug. 5, 2009 (KR) 10-2009-0072093

(51) Int. Cl. A21D 10/04

(52) U.S. Cl. 426/552

(57) ABSTRACT

The present invention relates to a batter mix composition with reduced oil absorption, wherein the effective amounts of each ingredient in the composition, for decreasing oil absorption and maintaining crisp texture, is as follows: starch 10 to 20 weight %, gum 0.1 to 0.3 weight % and baking powder 0.5 to 1.5 weight %. The batter mix composition of the present invention is prepared by mixing a selected starch, gum and baking powder in effective amounts. When compared with existing products, the composition of the present invention not only reduces oil absorption during the frying process, but also minimizes degradation of the crisp texture. The present invention allows the production of various fried products having low fat content and improved texture, thereby promoting public health and providing a useful innovation to the food service industry.

### FIELD OF INVENTION

The present invention is relates to a batter mix composition with reduced oil absorption, wherein the effective amounts of each ingredient in the composition, for decreasing oil absorption and maintaining crisp texture, is as follows: starch 10 to 20 weight %, gum 0.1 to 0.3 weight % and baking powder 0.5 to 1.5 weight %.

### BACKGROUND OF THE INVENTION

Lipid is one of the main nutritional contents which is an essential physiological energy source, and plays an important nutritional and biochemical role in our body. Also, it is an important factor for determining the taste, scent and texture of the food. However, the excessive ingestion of lipid into our body and increase of calories as a result cause bad effects on health such as obesity, and adult diseases. In Korea, the incidence of chronic degenerative diseases and adult disease including cardiovascular disease such as arteriosclerosis and coronary-artery disease, diabetes and obesity is rapidly increasing. This increase is due to the increased consumption of meat and high fat diet caused by the rapid economic growth and westernised dietary habits. Accordingly, the World Health Organisation (WHO) has advised that the lipid intake should be 30% of total calories taken, and saturated fat should not be over 10%. As the governmental policy recommending less lipid intake of the nation is being sought for, it is also necessary for the food industry to actively develop and research low fat/calorie food in accordance to the policy.

Deep frying is a traditional cooking method which is being used widely in homes, restaurant business and food industry. It is also called as art of cooking process as it provides crispy texture, spicy fragrance, and flavour. Also, deep frying uses high temperature of edible fat and oil (150-200° C.) to heat food. Therefore the heat is conveyed to the food from the edible fat and oil which is the heating medium, and the temperature of the surface is rapidly increased. Then the moisture from the food evaporates and the oil and fat transfers into the food leaving the surface of the food dry to form a hard crust. These processes result in sitological phenomena such as gelatinisation, caramelisation, fat oxidation and mass transport. However, deep fried food is a representative high calorie and high fat food which contains large amount of lipid. Furthermore, approximately 50% of the gross weight is lipid within the deep fried food. Likewise, the excessive intake of high fat/calorie deep fried food may not be beneficial for the consumers' health due to the large amount of oil and fat absorbed into the food during the process. Also, due to the requirement of nutritional indication on food including total fat, content of trans- fat, deep fried food may not be favoured by the consumers affecting the related industry.

Especially, in Korean homes, deep fried foods are mostly made by frying after mixing the food with batter mix. For example, batter mix is used for cooking chicken according to Korean Patent No 10-0473186 and Korean Patent No 10-0473185 and more. Especially, the Korean Patent No 10-0744830, “Batter mix composition for cheese patty and the manufacturing method of cheese patty employing same”, describes a batter mix composition composed of rice powder, gluten, isolated soy protein and dried albumin so that the batter used for cooking did not burst out maintaining its structure during the heat treatment and the expansion of the cheese. Also, the adhesivity of the batter to the cheese was good so that the cheese could be used directly as a patty, maintaining the taste and scent of the cheese.

However, so far the utility of the batter mix has been focused on the aspect of flavour and taste of the food. Research on batter mix with reduced oil absorption is limited, and there are no products in the market at present.

Furthermore, as the physical characteristics of the batter mix affect the customers taste, it is required to develop a batter mix with reduced oil absorption without causing any difference in the quality of the final product.

The inventors of the present invention performed research in order to produce batter mix with reduced oil absorption properties. As a result they described that corn starch, gellan Gum, and baking powder were effective in reducing the oil absorption within the batter mix composition, and produced the batter mix using the mentioned materials without affecting the taste. Finally, the optimum condition for minimising any changes of the taste was applied to complete the present invention.

### DETAILED DESCRIPTION OF THE INVENTION

### Technical Task

Therefore the aim of the present invention was to provide a batter mix composition which is characterised by reducing the absorption of oil during deep frying and also maintains the crispy texture of the final fried product.

### Technical Solution

The aim of the present invention was achieved by selecting gellan gum and baking powder for the batter mix composition that is effective for decreased oil absorption; selecting corn starch for adjusting the quality of the batter in order to show crispy texture; confirming that the oil absorption and the crispy texture of the fried food that has been manufactured using the mentioned batter mix composition has decreased and preserved respectively, referring to the measurement of oil absorption, viscosity and pick up value.

The present invention provides a batter mix composition containing the effective dose of starch, gums and baking powder.

“Batter mix” in the present invention, is a mixed powder formed material used for the batter for fried food, and in general the batter mix is composed of flour and additives. In the present invention, weak flour and additives such as corn powder, garlic powder, onion powder, pepper powder and vitamin B were used. Therefore, the batter mix described in the present invention indicates a mixture of weak flour and additives such as corn powder, garlic powder onion powder, pepper powder and vitamin B2.

“Effective dose” in the present invention, indicates the optimum amount which is used to cook the food using the batter mix composition which shows reduced oil absorption and crispy texture.

According to the present invention, as the amount of starch decreases, the oil content increases, but the viscosity and pick up value decreases. However, when the amount of starch increases, the oil content decreases but the viscosity and pick up value increases. When the amount of gums and baking powder decreases, the oil content decreases but the viscosity and pick up value increases. However, when the amount of gums and baking powder increases, the oil content increases but the viscosity and pick up value decreases.

Therefore, the composition of the batter mix is added with additives at their effective dose for making the final fried product which shows reduced oil absorption and crispy texture. Preferably, 10-20 weight percentage (%) of starch, 0.1-0.3 weight percentage (%) of gums and 0.5-1.5 weight percentage (%) of baking powder are added to the composition.

The mentioned starch in the present invention is used by choosing one or mixing two types of starches among corn starch, sweet potato starch, tapioca starch, and rice powder. However, the selection is not only limited to these, and other types of starches known in the field can be used.

The mentioned gums in the present invention is used by choosing one or mixing two types of gums among gellan gum, guar gum, and locust bean gum. However, the selection is not only limited to these, and other types of gums known in the field can be used.

### Effects of the Invention

The batter mix composition described in the present invention which is manufactured by mixing the effective doses of selected starch, gum, and baking powder, is useful for improving people's health and related food and the food service industry. The batter mix composition allows reduction of oil absorption and minimise the change of taste during deep frying, and therefore, producing various deep fried food with less fat and improved taste.

### BRIEF DESCRIPTION OF THE DRAWINGS

FIG. 1 is a graph showing the oil content of the batter added with different amounts of gellan gum.

FIG. 2 is a graph showing the viscosity of the batter added with different amounts of gellan gum.

FIG. 3 is a graph showing the pick up value of the batter added with different amounts of gellan gum.

FIG. 4 is a graph showing the oil content of the batter added with different amounts of corn starch.

FIG. 5 is a graph showing the viscosity of the batter added with different amounts of corn starch.

FIG. 6 is a graph showing the pick up value of the batter added with different amounts of corn starch.

FIG. 7 is a graph showing the oil content of the batter added with different amounts of gellan gum and corn starch.

FIG. 8 is a graph showing the viscosity of the batter added with different amounts of gellan gum and corn starch.

FIG. 9 is a graph showing the pick up value of the batter added with different amounts of gellan gum and corn starch.

FIG. 10 is a graph showing the oil content of the batter added with different amounts of baking powder.

FIG. 11 is a graph comparing the oil content of the control batter with the batter showing reduced oil absorption according to the present invention.

FIG. 12 is a graph comparing the viscosity of the control batter with the batter showing reduced oil absorption according to the present invention.

FIG. 13 is a graph comparing the pick up value of the control batter with the batter showing reduced oil absorption according to the present invention.

### MODE FOR IMPLEMENTATION OF INVENTION

The preferred method of implementation of the present invention is described below, referring to the examples in detail. However, the scope of the present invention is not limited to these examples.

### EXAMPLE

The most important finding of the present invention is the selection of the batter mix composition with reduced oil absorption during deep frying which gives crispy texture to the final product. Gellan gum and baking powder was selected to reduce oil absorption and corn starch was selected for maintaining the crispy texture of the batter.

For the batter mix composition, weak flour and additives such as corn powder, garlic powder, onion powder, pepper powder and vitamin B were used. Also, different amounts of gellan gum, baking powder and corn starch were added to the composition to measure the optimum ratio of composition by measuring the oil content, viscosity and pick up value of the batter.

### Example 1

### Measurement of Viscosity, Pick Up Value and Oil Content of the Batter After Adding Gellan Gum

In the present example, the oil content, viscosity and pick up value of the batter was measured after adding different amounts of gellan gum. CJ batter was used as a control. 0.5-2 weight percentage (%) of gellan gum was added to 100 g of batter mix composition mixed with 140 g of water to make the batter. Then the viscosity of the batter mix was measured using bostwick consistometer. Then the pick up value was measured from the sweet potato dipped in the batter which was in a regular form (diameter 60 mm×thickness 4 mm). Also, to measure the oil content, the sweet potato dipped in the batter was fried in soybean oil for 4 minutes and then cooled down for 7 minutes. Then the fried sweet potato was grinded using a mixer within liquid nitrogen and the fat was extracted for 6 hours using the soxhlet extractor using ethyl ether as a solvent.

Pick up value (%)=weight of the batter attached to the sweet potato/weight of fresh potato×100 Oil content (%=(Wi×Wo)/Wi×100

Wi: weight of sample before fat extraction, Wo: weight of sample after fat extraction

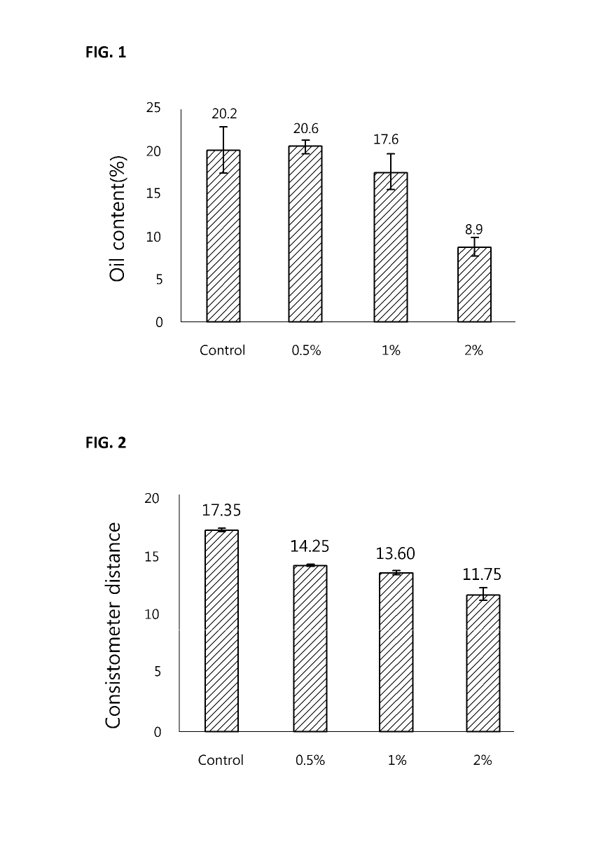

The oil content of the deep fried sweet potato added with gellan gum is shown in FIG. 1. According to FIG. 1, the oil content of the deep fried sweet potato added with gellan gum was significantly smaller than the control.

Also, the viscosity of the batter added with gellan gum is shown in FIG. 2. According to FIG. 2, adding gellan gum resulted in increased viscosity of the batter (shorter the consistometer distance, bigger the viscosity).

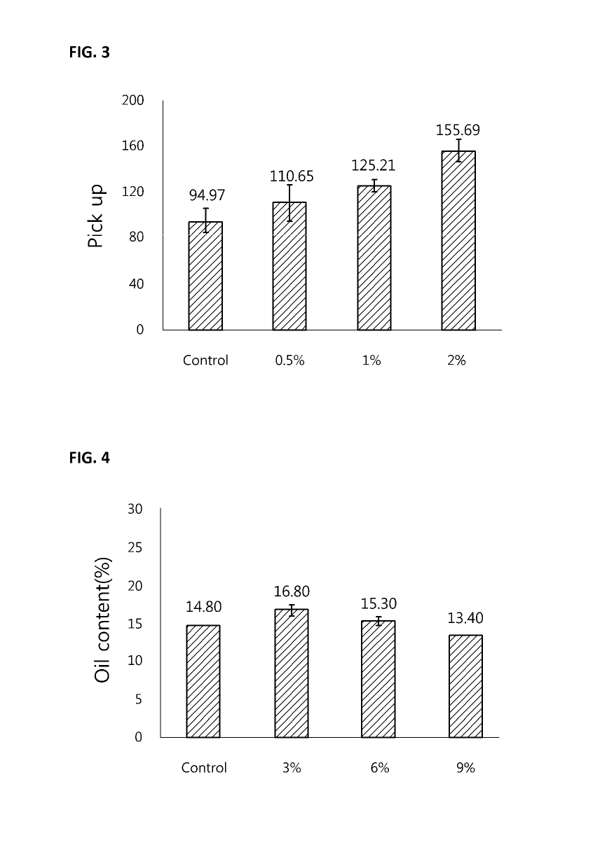

Also, the pick up value of the batter added with gellan gum is shown in FIG. 3. According to FIG. 3, adding gellan gum resulted in increased pick up.

### Example 2

### Measurement of Viscosity, Pick Up Value and Oil Content of the Batter After Adding Corn Starch

It has been described in example 1 that adding gellan gum to the batter mix resulted in decreased oil content, but increased viscosity and pick up value. Corn starch was selected to be added to the batter mix to decrease the viscosity while maintaining the decreased oil content. This is due to the fact that the increased viscosity has a negative effect on giving crispy texture to the final product.

In order to confirm this, various amounts of corn starch ranging from 3 to 9 weight percentage (%) was added to the matter mix to make the batter mix composition. Then the viscosity, pick up value and oil content of the batter was measured using the method described in Example 1.

The oil content of the deep fried sweet potato after adding corn starch is illustrated in FIG. 4. As shown in FIG. 4, the oil contents of the deep fried sweet potato added with corn starch of more than or equal to 6 weight percentage (%), were not very different compared with the control.

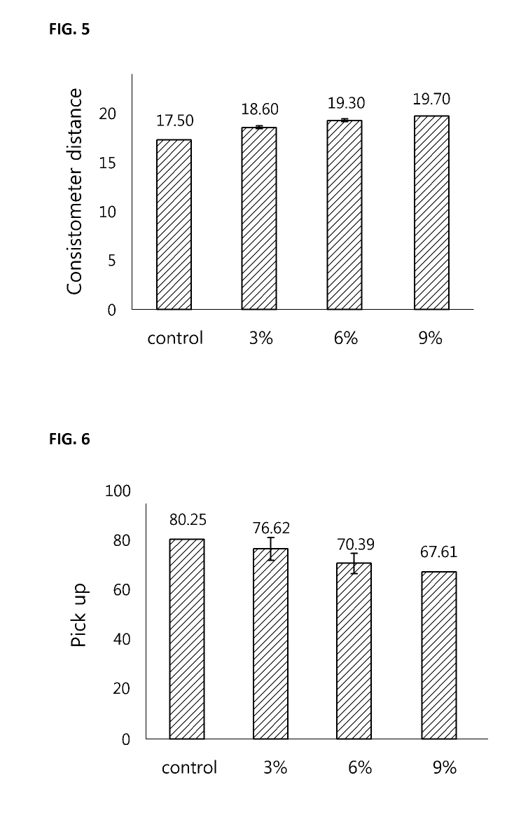

The viscosity of the batter after adding corn starch is illustrated in FIG. 5. As shown in FIG. 5, the viscosity of the batter decreased when more corn starch was added (longer the consistometer distance, smaller the viscosity).

The pick up value of the batter after adding corn starch is illustrated in FIG. 6. As shown in FIG. 6, as more corn starch was added to the batter, the pick up value of the batter decreased due to lowered viscosity.

### Example 3

### Measurement of Viscosity, Pick Up Value and Oil Content of the Batter After Adding a Mixture of Gellan Gum and Corn Starch

It was described that adding gellan gum to the batter mix resulted in decreased oil absorption, but the viscosity and pick value of the batter had increased which may have had an effect on the crispness of the batter. Therefore, in order to maintain the effect of decreased oil absorption and improve the crispy texture, a mixture of gellan gum and corn starch was added to the batter mix. Then the oil content, viscosity and pick up value of the batter was measured using the methods described in Example 1.

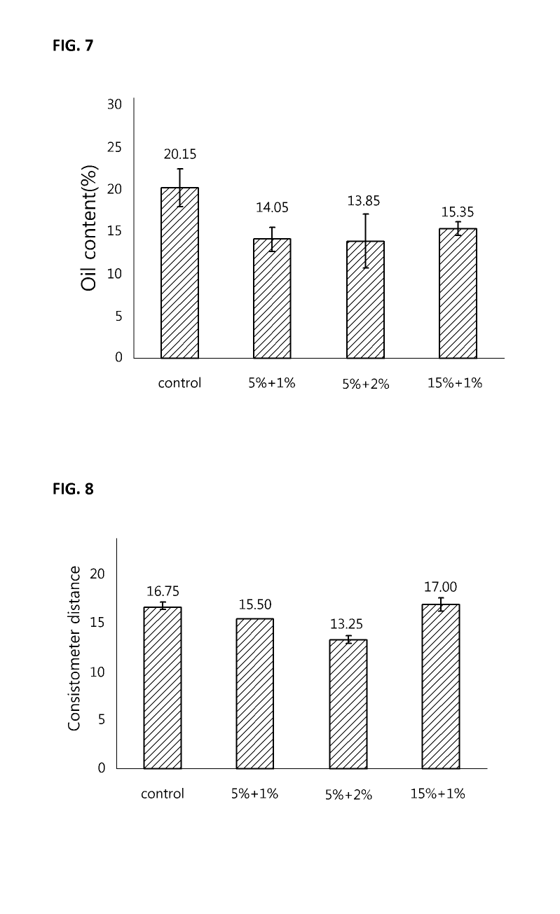

The oil content of the deep fried sweet potato added with the mixture of gellan gum and corn starch is shown in FIG. 7. As shown in FIG. 7, the oil content of the deep fried sweet potato added with the mixture of gellan gum and corn starch was significantly lower than the control.

The viscosity of the batter added with the mixture of gellan gum and corn starch is shown in FIG. 8. As shown in FIG. 8, the viscosity of the batter added with a mixture of corn starch and 1 weight percentage (%) of gellan gum was similar to the control. However, when the mixture of corn starch and 2 weight percentage (%) of gellan gum was added, the viscosity significantly increased compared to the control (shorter the consistometer distance, bigger the viscosity).

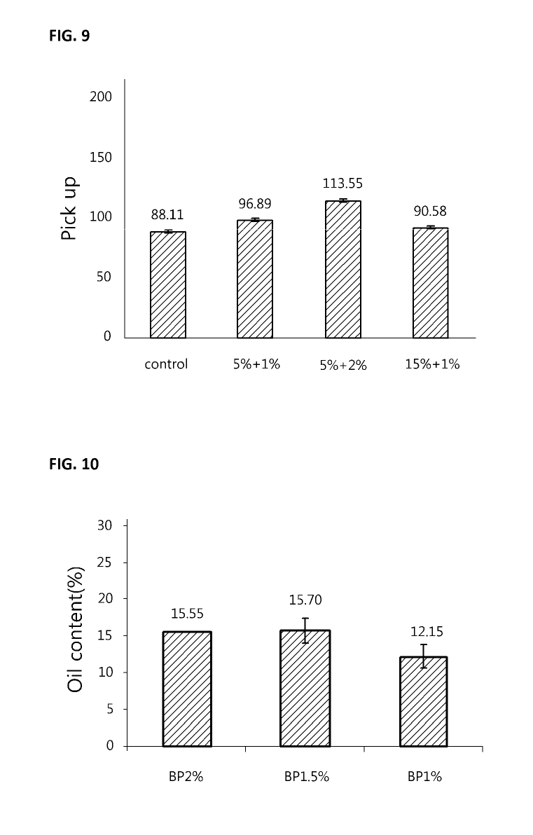

The pick up value of the batter added with a mixture of gellan gum and corn starch is shown in FIG. 9. As shown in FIG. 9, the pick up value of the batter added with a mixture of corn starch and 1 weigh percentage (%) of gellan gum was similar to the control. However, when the mixture of corn starch and 2 weight percentage (%) of gellan gum was added, the pick up value significantly increased due to the increased viscosity.

### Example 4

### Measurement of the Oil Content After Adjusting the Amount of Baking Powder

Adding baking powder creates pores in the batter during deep frying which could assist the absorption of oil. Therefore, the oil content of the batter after adding different amounts of baking powder was measured using the method described in Example 1.

The oil content of the deep fried sweet potato made with different amounts of baking powder is illustrated in FIG. 10. As shown in FIG. 10, as the amount of baking powder decreases, the oil content also decreases.

### Example 5

### The comparison of the Oil Content Between an Optimised Batter Mix Composition for Reduced Oil Absorption With Control

According to the mentioned experiments, an optimised batter mix composition with reduced oil absorption was made by adding the selected 10-20 weight percentage (%) of corn starch, 0.1-0.3 weight percentage (%) of gellan gum, 0.5-1.5 weight percentage (%). The rest that were added to the batter mix composition were 75-85 weight percentage (%) of weak flour, 1-5 weight percentage (%) of additives (Table 1). The oil content, viscosity and pick up value of the batter and the CJ batter (control) were measured to be compared with each other.

TABLE 1
The batter mix composition according to the present invention

| Material | Mix proportion (weight percentage (%)) |
|---|---|
| Weak flour | 75.0-85.0 |
| Corn starch | 10.0-20.0 |
| Corn powder | 2.0-3.0 |
| Refined salt | 1.0-2.0 |
| Baking powder | 0.5-1.5 |
| Gellan gum | 0.1-0.3 |
| Garlic powder | 0.1-0.3 |
| Black pepper powder | 0.005-0.015 |
| Vitamin B2 | 0.001-0.003 |
| Total | 100.00 |

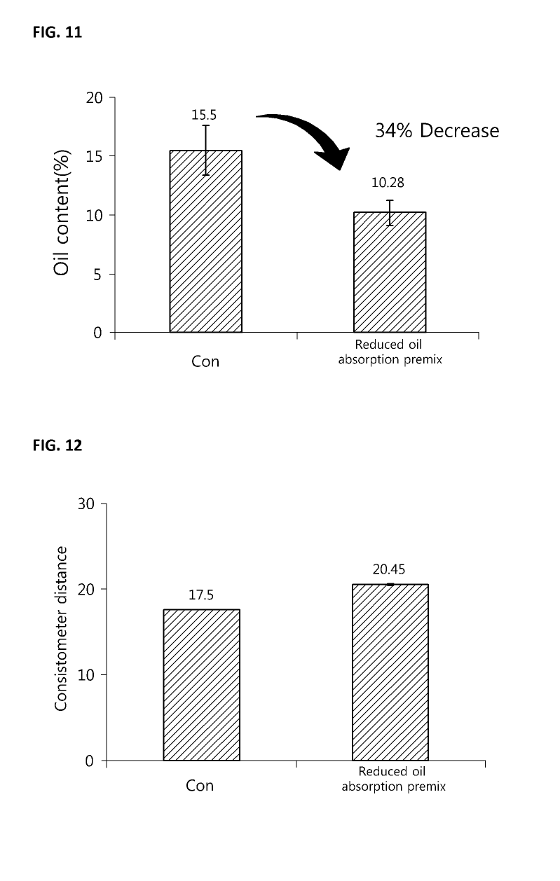

The oil content of the batter mix composition with reduced oil absorption and CJ batter was measured and illustrated in FIG. 11. As shown in FIG. 11, the oil content of the batter mix composition with reduced oil absorption was decreased by 34% compared with the CJ batter.

The viscosity of the batter mix composition with reduced oil absorption and CJ batter was measured and illustrated in FIG. 12. FIG. 12 shows that the viscosity of the batter mix composition with reduced oil absorption had decreased compared with the CJ batter.

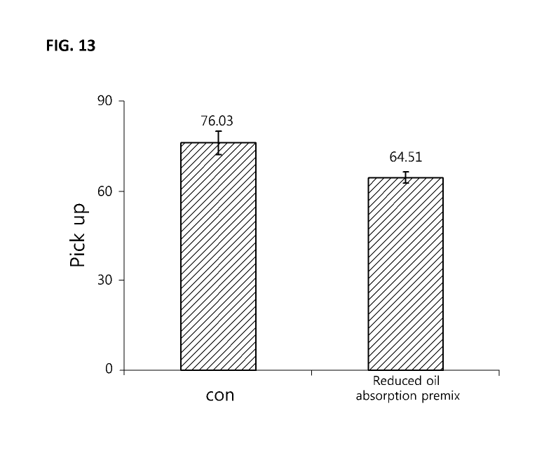

The pick up value of the batter mix composition with reduced oil absorption and CJ batter was measured and illustrated in FIG. 13. As shown in FIG. 13, the pick up value of the batter mix composition with reduced oil absorption showed decreased pick up value compared with the CJ batter. This is due to the decreased viscosity of the batter mix composition. The results indicate that the batter mix composition absorbs less oil even though the batter is thin around the sweet potato (FIG. 11).

### Example 6

### Food Taste Testing and Sensory Evaluation of the Deep Fried Sweet Potato Made With the Mentioned Batter Mix

Food taste testing was performed on the deep fried sweet potato made with the batter mix composition described in Example 5.

The level of satisfaction after taste testing the deep fried sweet potato was explored among 160 students who were within 20-30 years of age, living in Seoul. The results are shown in Table 2.

TABLE 2
Sensory evaluation of consumers. (maximum score is ten)

| | Control | Batter mix composition with |
|---|---|---|
| Preference | (CJ batter) | reduced oil absorption |
| General preference | 5.7 | 5.7 |
| Chewing (texture) preference | 5.1 | 5.6 |
| Sensibility inside the mouth | 5.1 | 5.4 |
| Crispness preference | 5.5 | 6.0 |
| Degree of crispness | 5.3 | 5.7 |
| Aftertaste preference | 5.8 | 5.8 |
| Off flavour intensity | 4.7 | 4.4 |

As shown in Table 2, the preference results of the sensory evaluation test were compared between control and batter mix composition with reduced oil absorption made with corn starch and gellan gum. It shows that the batter mix composition has similar quality preference to the control batter.

This investigation shows that the batter mix made with corn starch, gellan gum and baking powder satisfies the consumers' appetite. Also it indicates that the batter mix composition with reduced oil absorption may create a new consuming market

1. A batter mix composition composed of effective doses of starch, gum and baking powder.

2. The batter mix composition of claim 1, wherein the batter mix composition contains 10-20 weight percentage (%) of starch, 0.1-0.3 weight percentage (%) of gum and 0.5-1.5 weight percentage (%) of baking powder within the total 100 weight percentage (%) of batter mix.

3. The batter mix composition of claim 1, wherein the mentioned starch is either selected from the group composed of corn starch, wheat starch, sweet potato starch, tapioca starch, rice powder; or is a mixture of more than two from the group.

4. The batter mix composition of claim 1, wherein the mentioned gum is either selected from the group composed of gellan gum, guar gum, locust bean gum; or is a mixture of more than two from the group.
